(19) United States
(12) Patent Application Publication
(10) Pub. No.: US 2015/0032495 A1
(43) Pub. Date: Jan. 29, 2015

(54) System and Method for User Controlled Cost Based Network and Path Selection across Multiple Networks

(71) Applicant: FutureWei Technologies, Inc., Plano, TX (US)

(72) Inventors: Gamini Senarath, Ottawa (CA); Alex Stephenne, Stittsville (CA); Ho-Ting Cheng, Stittsville (CA)

(21) Appl. No.: 13/951,254

(22) Filed: Jul. 25, 2013

(51) Int. Cl. G06Q 10/06

(52) U.S. Cl. CPC G06Q 10/06313
USPC 705/7.23

(57) ABSTRACT

Embodiments are provided to enable a user controlled path selection for servicing content requests from users. In an embodiment, a user device sends a cost request for a service to a network, and in return receives cost information for the service from the network. The user device then determines, according to the cost information, cost for one or more paths across the network. Upon determining acceptable cost for a path from the paths, the user device selects the path for receiving the service. In another embodiment, a network node coupled to links receives loading information from neighbor nodes coupled to neighbor links, and evaluates cost using loading information for the links and the received loading information for the neighbor links. When the network node receives a cost request from a user for a service, the node returns cost information for the service.

### TECHNICAL FIELD

The present invention relates to the field of network communications and optimization, and, in particular embodiments, to a system and method for user controlled cost based network and path selection across multiple networks.

### BACKGROUND

In various network scenarios, users can request services from networks by sending requests and receiving, in response, the requested services from the networks. For instance, in a cellular network scenario, a mobile device or user equipment (UE) accesses a base station or a radio transmitter/receiver (or radio transceiver), e.g., an eNB, to send a request for a media or content to be displayed on the device. The request is forwarded by the base station through the cellular network to a server providing the media or content. The request may be forwarded through different network components or nodes, for example through multiple networks (e.g., including the Internet) to fetch the requested content from the server. Upon approval, the network forwards the requested content back to the user device or UE. This process also includes determining a route or path through the one or more networks to forward the requested content back to the user. Typically, the network(s) and/or the nodes in the network(s) determine this path according to network conditions (such as based on load at different nodes, bandwidth on links, or other resources), cost functions for routing, routing protocols, user preferences, and/or other factors. However, the user has no or limited participation in the path determination process. Allowing the user to determine or control the path selection for servicing user requests has advantages, such as to avoid using one or more dedicated components in the network for handling the path selection process. However, this can also lead to network utilization inefficiencies as network resources may not be used optimally across different users to increase the number of users or services the system could handle compared to network controlled systems. On the other hand, since in the future networks the user requests may be served taking the on-demand pricing, the user movement, affordability, and satisfaction into consideration, user controlled network access could lead to a more dynamic, flexible, and demand-based implementation, such as in the case of mobile users and multiple networks of different operators. There is a need for a system and method that enables user controlled network and path selection across multiple networks.

### SUMMARY OF THE INVENTION

In accordance with an embodiment, a method for user controlled path selection to receive a network service includes sending, at a user device, a cost request for a service to one or more networks. The user device then receives cost information for the service from the one or more networks, and determines, according to the cost information, cost for one or more paths across the one or more networks. Upon determining acceptable cost for a path from the paths, the user device selects the path for receiving the service.

In accordance with another embodiment, a method for user controlled path selection to receive a network service includes receiving, at a network node coupled to one or more links in a network, loading information from one or more neighbor nodes coupled to one or more neighbor links. The loading information indicates load of traffic at the one or more neighbor links. The network node then evaluates cost using local loading information for the one or more links and the received loading information for the one or more neighbor links. When the network node receives a cost request originating from a user for a service, the network node returns, in a response to the user, cost information for the service from the evaluated cost.

In accordance with another embodiment, a user device supporting controlled path selection to receive a network service includes a processor and a computer readable storage medium storing programming for execution by the processor. The programming includes instructions to send a cost request for a service to one or more networks, receive cost information for the service from the one or more networks, and determine, according to the cost information, cost for one or more paths across the one or more networks. Upon determining acceptable cost for a path from the paths, the path is selected for receiving the service.

In accordance with yet another embodiment, a network component supporting controlled path selection to receive a network service includes a processor and a computer readable storage medium storing programming for execution by the processor. The programming includes instructions to receive loading information from one or more neighbor nodes coupled to one or more neighbor links. The loading information indicates load of traffic at the one or more neighbor links. The cost of one or more links is evaluated at the network component using local loading information for the one or more links and the received loading information for the one or more neighbor links. Upon receiving a cost request sent from a user for a service, the network component returns, in a response to the user, cost information for the service from the evaluated cost.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example of a user service access scenario using multiple networks;

FIG. 2 illustrates an embodiment of a pre-path selection scheme;

FIG. 3 illustrates an embodiment of a user oriented cost request/response scheme;

FIG. 4 illustrates an embodiment of a user controlled path selection method; and

FIG. 5 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

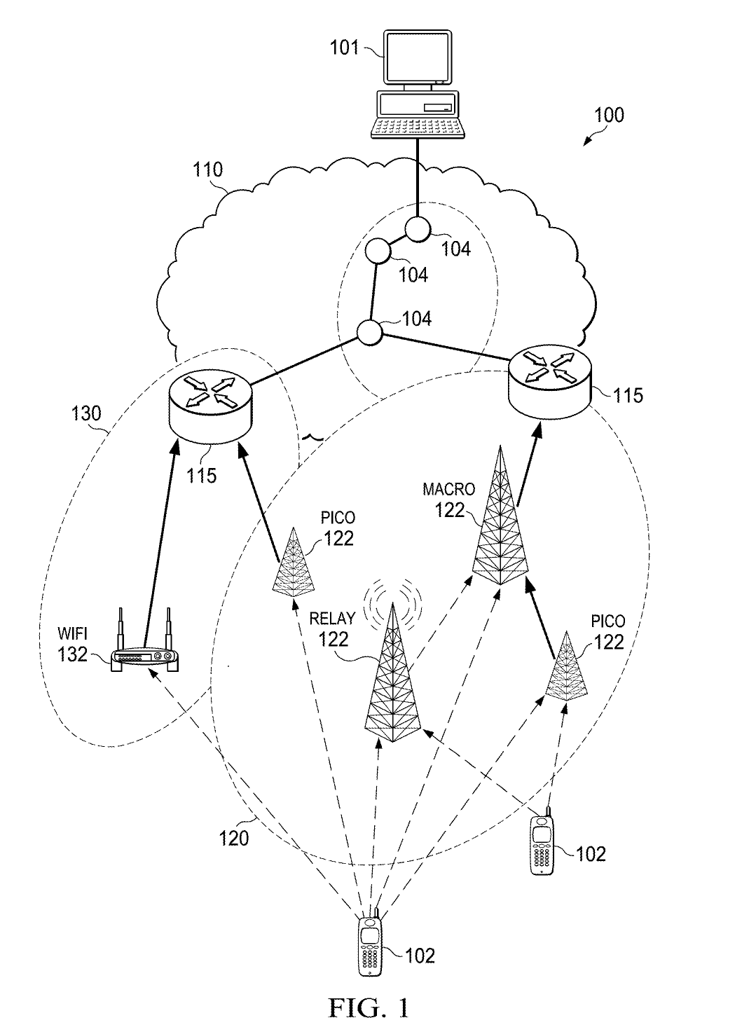

FIG. 1 shows an example of a user service request scenario 100 for multiple networks. One or more user devices or UEs 102, such as smartphones, laptop computers, tablet computers, or other portable devices with wireless connection capability, can access one or more networks to request content. The content may be media content (such as video and/or voice), application data (such for an application running on the UE), or other content (such as weather, time, date, calendar, or storage data). The networks may be different technology networks, for example, a cellular network 120 (a 3GPP standard cellular network, such as LTE, GSM, or CDMA network), a Wi-Fi network 130 (a wireless local access network (WLAN) or IEEE 802.11 standards network), and the Internet 110 (or other IP based network). The cellular network 110 comprises radio transceivers or node 122, e.g., base stations (such as eNBs), relays, macro cells, and/or pico cells. The Wi-Fi network 130 comprises one or more access points (APs) 132, also referred to as hotspots, such as Wi-Fi wireless modems or routers. The Internet or IP network 110 comprises a plurality of nodes 104, e.g., including routers, bridges, switches, and/or servers. The Internet or IP network 110 may be coupled to the cellular network 120 and the Wi-Fi network 120 via edge nodes 115.

The content may be requested and provided from a source or server 101 through the networks. For example, a UE 102 can send a request for content to a radio node 122 in the cellular network 120 or an access point 132 in the Wi-Fi network 130. The request is then forwarded through the network to reach the server 101, via the Internet 110. In response, the content is sent back through a path across the networks to the requesting UE 102. Typically, the networks determine or control the path selection for forwarding the content from the server 101 to the UE 102. This is can be done by a central or dedicated network server or component or in a distributed manner by the nodes in the networks, such as using a distributed routing and signaling protocol. However, the networks may be operated by different operators and a network approach to control the path selection requires synchronization between different controllers or entities and/or enabling suitable and compatible protocols across the networks. Further, in the case of a moving UE 102, e.g., during a handover procedure from/to a radio node 122 or an AP 132, the network controlled path selection process becomes more complicated.

Embodiments are provided herein to enable a user controlled path selection for servicing content requests from users. The embodiments can be used for servicing requests on UEs in wireless networks (e.g., cellular and Wi-Fi networks). Similarly, the schemes can be used for servicing other types of clients or client devices in any suitable network types or technologies. The user controlled approach removes the need to use centralized or dedicated components in the network, and hence the associated cost. This approach also replaces other more complicated distributed path routing protocols, such as Resource Reservation Protocol (RSVP) for minimum cost path computation. The user controlled path selection scheme can be more suitable to ensure quality of experience (QoE) requirement for users, simpler to implement, and more efficient for mobile users. For example, in the case of wireless networks, user handover may be done more smoothly by user choosing multiple paths associated with the move. Also this scheme allows load balancing of traffic in the network, where the cost or load is calculated for individual links and nodes and the paths are selected independently by individual users.

The embodiments allow direct cost negotiation without a central admission control or path selection unit. A user can send a service cost request message through available paths in a network, for example in the scenario 100. Hence, for each link associated with the request, cost information or parameters are sent to the user. The cost information or parameter is based on pre-known cost of adding the type of requested service for each link that receives the request and neighbor links. Pre-known cost can be evaluated, at an initial set up phase (offline phase) prior to initiating the request, by exchanging information between nodes of neighbor links and running offline evaluation for different environments (e.g., different load scenarios). After receiving the cost information, the user can decide which if any path to use for receiving the requested service or content, and accordingly can send a path reservation request. When the path reservation request is acknowledged by the links, the data session can be started.

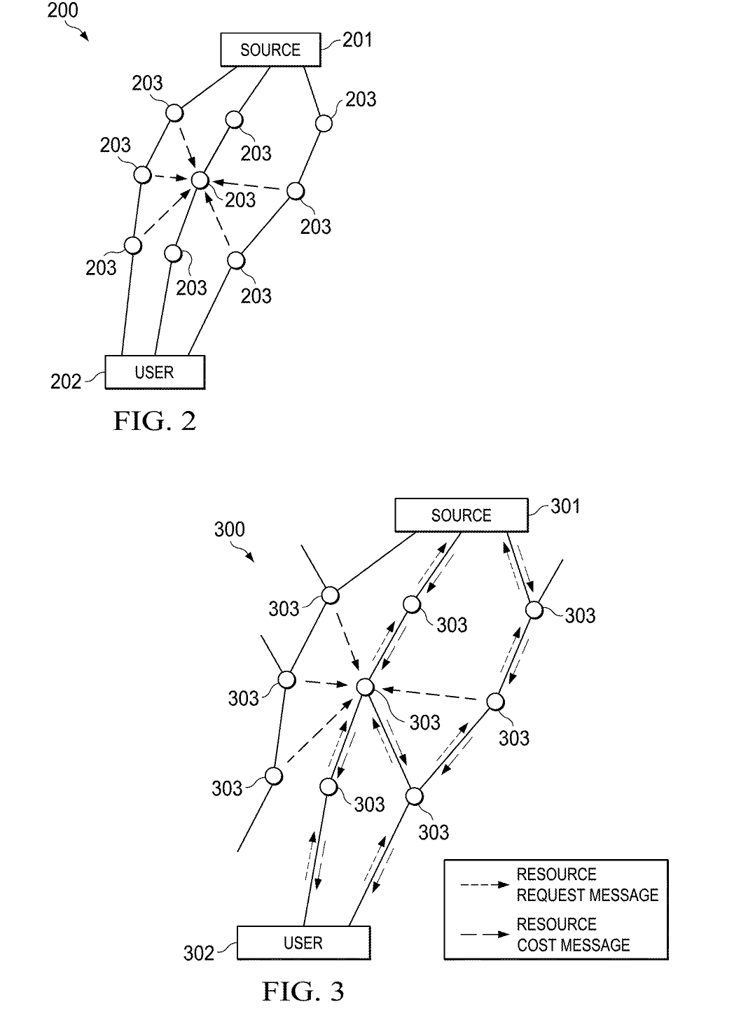

FIG. 2 shows an embodiment of a pre-path selection scheme 200 that can be implemented in a wireless network (e.g., cellular or Wi-Fi) in an offline mode, e.g., in a setup phase prior to sending a user request. The scheme 200 involves nodes 203 of neighbor links that couple between a source 201 and an access node (e.g., a base station or an AP) for a user 202. The links include radio links or connections between radio nodes. The neighbor links form one or more paths between the source 201 and the user 202, which may connect to the nodes 203 via one or more alternative access nodes. The nodes 203 of the neighbor links cooperate with each other (via signaling) to share wireless signal interference impact to resource usage between the neighbor links at different load levels (e.g., no wireless traffic load, light load, medium load, high load) and for different services or service types (e.g., data rates). For instance, the nodes 203 exchange interference levels under the various load levels at the neighbor links. This information can be stored locally at the nodes 203, e.g., in local databases referred to herein as resource cost table (RCT). Each node 203 can set its loading levels, add one or more entries for services under different neighbor loading levels, receive neighbor reports for cost (e.g., interference level) due to resource usage, evaluate cost, and store its cost and neighbor cost in the local RCT.

Nodes 203 can have a virtual signaling path to the neighbors to obtain the neighbor cost and loading information and to do offline evaluation. The nodes 203 can add emulated traffic to find out the impact of service addition to their neighbors. Each node 203 can provide a single cost number which includes the interference impact to the neighbors. The information exchanged between the nodes 203 of the neighbor links may be updated over time to account for changing network conditions. The nodes may also evaluate future cost information, such as using expected loading scenarios. In some embodiments, the nodes 203 may lower the reported cost information to make the links more attractive for the user controlled path selection process. A similar pre-path selection scheme can be implemented between nodes of other networks with physical fixed links (e.g., cable or optical fiber links). In this case, the nodes of neighbor links exchange traffic load cost information in terms of resources (e.g., bandwidth or rate) instead of interference information to build the local RCTs.

FIG. 3 shows an embodiment of a user a user oriented cost request/response scheme 300 that can be implemented after the scheme 200. After storing the cost information in local RCTs at the nodes 303, a user 302 connects to an access node (a base station or an AP) and sends a resource request message (or service cost request message) to the network to request cost of a service on links along possible paths in the network. The request message is then forwarded on the links of the paths upstream until reaching a source 301 of the services. Each node 303 that receives the cost request message may send it to its neighboring nodes 303 until reaching the source 301. Each node 303 that receives the request message responds to the user 302 by a resource cost message that indicates cost information for associated link(s). The cost information is retrieved from the local databases or RCTs of the nodes 303 and can include cost information for one or more load levels and services (or service types). The cost information may be cost values or parameters. The cost values can be computed using cost functions at the nodes 303. Alternatively, the cost parameters are sent to the user 302, which uses the parameters to evaluate the cost of each link using d predetermined cost functions, and hence the total cost for paths formed by the links. For this purpose, a set of standard or predetermined cost functions may be provided to the user 302, e.g., as a function of loading statistics. The parameters of the functions may be dynamically changed by the owner of each link and sent to the user 302, thus providing full flexibility for demand based charging. For example, a plurality of standard cost functions are predefined (by the network), each having several parameters (cost parameters). The nodes 303 provide the parameters and optionally specific functions to be used to evaluate the cost by the user. The choice of the function can be chosen by the user using a parameter for this purpose, e.g., a “function_identifier”. This allows the implementation of game theoretic or other distributed optimization techniques. The source 301 may also receive the request and respond with cost information. In another embodiment, the request message is sent first to the source 301, which responds with a resource cost message. The cost message is then flooded down through the neighboring nodes 303 until reaching the user 301. Upon propagating through a group of nodes 303, each cost message can aggregate the cost information (values or parameters) of the propagated nodes 303.

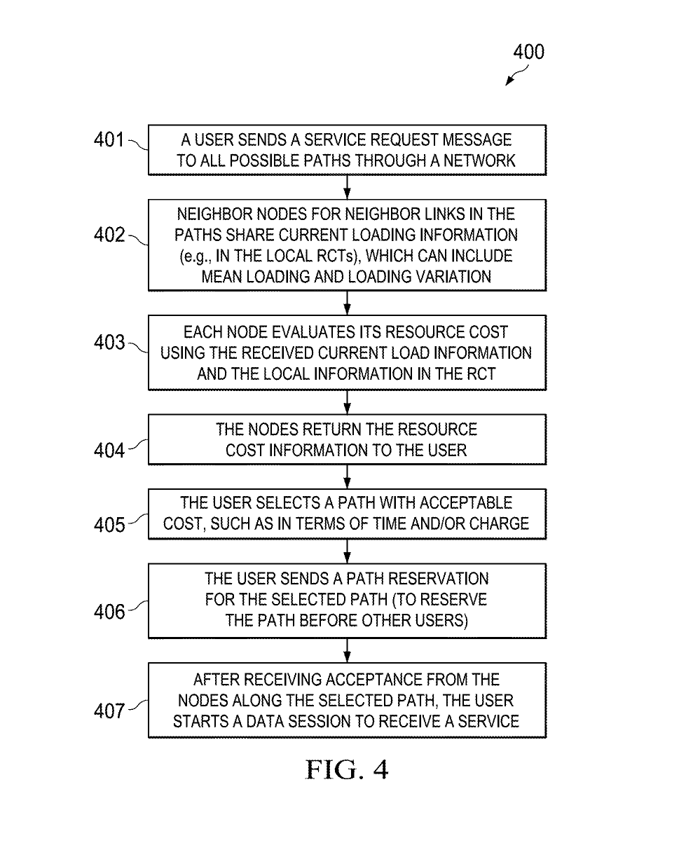

FIG. 4 shows an embodiment of a user controlled path selection method 400 that can be implemented to enable a user to select a path for receiving a requested service. At step 401, the user sends a service request message to all possible paths through a network. At step 402, neighbor nodes for neighbor links in the paths share current loading information (e.g., in the local RCTs), which can include mean loading and loading variation parameters or values. For instance, in the case of wireless or radio links, the links whose transmitters interfere with neighboring links would share the loading information with those links using the controlling nodes. There may be additional negotiation phases where a user may negotiate with the controlling nodes the link usage charges. At step 403, each node evaluates its resource cost using the received current load information and the local information in the RCT. The cost includes current cost and optionally future expected cost. For example, future expected cost information can be considered by a mobile user during a handover procedure to determine a suitable path to select for completing the handover. At step 404, the nodes return the resource cost information to the user. The nodes can also provide the user with loading information with the cost information. At step 405, the user selects a path with acceptable cost, such as in terms of time and/or charge (pricing). Otherwise, if no path with acceptable cost is found, then the method 400 ends. The user uses the cost information and loading information (if received) to evaluate the cost of one or more possible paths. At step, 406, the user sends a path reservation for the selected path (to reserve the path before other users). At step 407, after receiving acceptance from the nodes along the selected path, the user starts a data session to receive a service.

In the path selection step at the user, the user can use, in addition to the received cost information, other information including mobility information for the user, QoE information, traffic expectation and urgency, the amount the user is willing to pay, and/or other user available information, preferences, requirements, or criteria. The user can then select the path according to user preferences, for example, a least cost path acceptable by the user in terms of pricing and/or wait time. In an embodiment, the access nodes (e.g., base station or AP) get the link cost and loading from the nodes along the paths, before or after receiving a service request from a user. After receiving the request, each access node sends the associated minimum cost path to the user. The user can then select a path according to the criteria described above.

The user controlled path selection scheme and embodiments above allow the operators of networks to dynamically change the pricing to user based on demand, for example, so that users and operators can get a better deal. The users may not have to get permission from the network for each and every session. For instance, a user may have a contract with an operator, where a user can accept a demand based pricing scheme. During congestion time, the user may refrain from using the network (due to cost), which helps the network with congestion. The contract may also allow the network or operator to terminate a session for a user after a pre-determined amount of active time. In an embodiment, the user may also send a price reduction request as part of negotiation with the network.

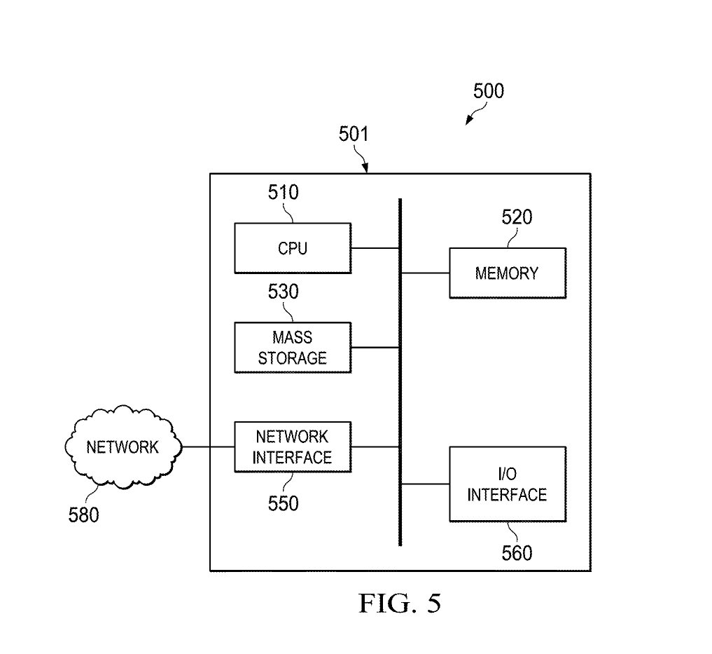

FIG. 5 is a block diagram of a processing system 500 that can be used to implement various embodiments. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 500 may comprise a processing unit 501 equipped with one or more input/output devices, such as a network interfaces, storage interfaces, and the like. The processing unit 501 may include a central processing unit (CPU) 510, a memory 520, a mass storage device 530, and an I/O interface 560 connected to a bus. The bus may be one or more of any type of several bus architectures including a memory bus or memory controller, a peripheral bus or the like.

The CPU 510 may comprise any type of electronic data processor. The memory 520 may comprise any type of system memory such as static random access memory (SRAM), dynamic random access memory (DRAM), synchronous DRAM (SDRAM), read-only memory (ROM), a combination thereof, or the like. In an embodiment, the memory 520 may include ROM for use at boot-up, and DRAM for program and data storage for use while executing programs. In embodiments, the memory 520 is non-transitory. The mass storage device 530 may comprise any type of storage device configured to store data, programs, and other information and to make the data, programs, and other information accessible via the bus. The mass storage device 530 may comprise, for example, one or more of a solid state drive, hard disk drive, a magnetic disk drive, an optical disk drive, or the like.

The processing unit 501 also includes one or more network interfaces 550, which may comprise wired links, such as an Ethernet cable or the like, and/or wireless links to access nodes or one or more networks 580. The network interface 550 allows the processing unit 501 to communicate with remote units via the networks 580. For example, the network interface 550 may provide wireless communication via one or more transmitters/transmit antennas and one or more receivers/receive antennas. In an embodiment, the processing unit 501 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for user controlled path selection to receive a network service, the method comprising:
sending, at a user device, a cost request for a service to a network;
receiving cost information for the service from the network;
determining, according to the cost information, cost for one or more paths across the network; and
upon determining acceptable cost for a path from the paths, selecting, at the user device, the path for receiving the service.

2. The method of claim 1, wherein the cost information includes cost parameters that are used with a cost function at the user device to determine cost for the one or more paths.

3. The method of claim 1, wherein the selected path has a lowest cost among the paths across the network.

4. The method of claim 3, wherein the lowest cost has a lowest pricing regardless of wait time, lowest wait time regardless of pricing, or a lowest combination cost pricing and wait time for receiving the service at the user device.

5. The method of claim 1 further comprising:
receiving loading information for links in the network; and
selecting the path according to the loading information with the cost information.

6. The method of claim 1 further comprising:
sending a path reservation request to reserve the selected path; and
upon acknowledgement from the network, receiving the service along the selected path.

7. A method for user controlled path selection to receive a network service, the method comprising:
receiving, at a network node coupled to one or more links in a network, loading information from one or more neighbor nodes coupled to one or more neighbor links, the loading information indicating load of traffic at the one or more neighbor links;
evaluating cost at the network node using local loading information for the one or more links and the received loading information for the one or more neighbor links;
receiving a cost request from a user device for a service; and
returning, in a response to the user device, cost information for the service from the evaluated cost at the network node.

8. The method of claim 7, wherein the evaluated cost at the network node is for resources for the one or more links coupled to the network node.

9. The method of claim 7, wherein the evaluated cost at the network node includes current cost according to current local loading information at the network node and current loading information from the one or more neighbor nodes and future expected cost according to expected future local loading information at the network node and expected future loading information from the one or more neighbor nodes.

10. The method of claim 7, wherein the cost information returned to the user includes wireless signal interference information.

11. The method of claim 7 further comprising receiving, at the network node from the one or more neighbor nodes, cost for resources for the one or more neighbor links coupled to the one or more neighbor nodes.

12. The method of claim 11, wherein the cost for resources includes wireless signal interference information.

13. The method of claim 7, further comprising sending, at the network node, loading information to the one or more neighbor nodes, the loading information indicating load of traffic at the one or more links coupled to the network node.

14. The method of claim 7 further comprising sending, to the one or more neighbor nodes, the cost at the network node for the one or more links coupled to the network node.

15. The method of claim 7 further comprising:
forwarding, at the network node through the network, the cost request for a service to a source of the service;
receiving a cost message for the service from the source;
aggregating the cost at the network node to the cost message; and
forwarding the cost message towards the user.

16. The method of claim 7, wherein the cost at the network node is evaluated for a plurality of loading scenarios, a plurality of service types, or both a plurality of loading scenarios and service types.

17. A user device supporting controlled path selection to receive a network service, the user device comprising:
a processor; and
a computer readable storage medium storing programming for execution by the processor, the programming including instructions to:
send a cost request for a service to a network,
receive cost information for the service from the network,
determine, according to the cost information, cost for one or more paths across the network, and
upon determining acceptable cost for a path from the paths, select the path for receiving the service.

18. The user device of claim 17, wherein the received cost information includes cost paramters or values and cost function definition for links across the network.

19. The user device of claim 18, wherein the cost information includes current cost information and future expected cost information for the links.

20. The user device of claim 18, wherein the links are wireless links, and wherein the cost information includes wireless signal interference information for the wireless links.

21. A network component supporting controlled path selection to receive a network service, the network component comprising:
a processor; and
a computer readable storage medium storing programming for execution by the processor, the programming including instructions to:
receive loading information from one or more neighbor nodes coupled to one or more neighbor links, the loading information indicating load of traffic at the one or more neighbor links;
evaluate cost of one or more links at the network component using local loading information for the one or more links and the received loading information for the one or more neighbor links;
receive a cost request for a service, the cost request sent from a user; and
return, in a response to the user, cost information for the service from the evaluated cost at the network component.

22. The network component of claim 21, wherein the programming further includes instructions to store the evaluated cost at a resource cost table in the computer readable storage medium.

23. The network component of claim 21, wherein the programming further includes instructions to:
forward the cost request for a service to a source of the service in a network;
receive, form the source, a cost message for the service;
aggregate the cost at the from the source to the cost message; and
forward the cost message towards the user.

24. The network component of claim 21, wherein the cost information returned to the user includes wireless signal interference information, and wherein the network component is a wireless access point.
